(19) United States
(12) Patent Application Publication
(10) Pub. No.: US 2006/0276566 A1
(43) Pub. Date: Dec. 7, 2006

(54) Particle size, percent drag effeciency and molecular weight control of bulk polymer polymerized polyalpha-olefins using high shear material processors

(75) Inventors: Thomas Mathew, Tulsa, OK (US); Nagesh S. Kommareddi, Broken Arrow, OK (US); Lu Chien Chou, Tulsa, OK (US); Jeffery R. Harris, Tulsa, OK (US); Chee Ling Tong, Penang (MY)

Correspondence Address: MADAN, MOSSMAN & SRIRAM, P.C., 2603 AUGUSTA, SUITE 700, HOUSTON, TX, 77057, US

(73) Assignee: Baker Hughes Incorporated

(21) Appl. No.: 11/447,396

(22) Filed: Jun. 6, 2006

Related U.S. Application Data
(60) Provisional application No. 60/687,987, filed on Jun. 7, 2005.

(51) Int. Cl. C09K 3/00

(52) U.S. Cl. 523/175

(57) ABSTRACT

High shear materials processing produces polymer drag reducing agent (DRA) slurries without cryogenic temperatures or conventional grinding. The homogenizing or size reduction, as well as controlled molecular weight reduction, of polymer such as poly(alpha-olefins), is achieved by the use of pre-ground polymer and at least one liquid, non-solvent for the polymer DRA in a high shear materials processor such as a homogenizer. In one non-limiting embodiment of the invention, the homogenizing is conducted at ambient temperature. Examples of suitable non-solvents include water and non-aqueous non-solvents including, but not necessarily limited to, alcohols, glycols, glycol ethers, ketones, and esters, having from 2-6 carbon atoms, and combinations thereof. The polymeric DRA may be homogenized to an average particle size of about 300 microns or less.

### CROSS-REFERENCE TO RELATED APPLICATION

This application claims the benefit of U.S. Provisional Application No. 60/687,987 filed Jun. 7, 2005.

### TECHNICAL FIELD

The invention relates to processes for directly producing slurries of finely divided polymeric drag reducing agents through the use of homogenization techniques via utilization of a “high shear materials processor.” Most particularly the invention pertains to processes for producing slurries of fine particulates of polymeric drag reducing agents that do not require conventional grinding of the solid polymeric drag reducing agent, cryogenically or otherwise, and that not only reduce particle size but also molecular weight.

### TECHNICAL BACKGROUND

The use of polyalpha-olefins or copolymers thereof to reduce the drag of a hydrocarbon flowing through a conduit, and hence the energy requirements for such fluid hydrocarbon transportation, is well known. These drag reducing agents or DRAs have taken various forms in the past, including slurries or dispersions of ground polymers to form free-flowing and pumpable mixtures in a liquid medium. A problem generally experienced with simply grinding the polyalpha-olefins (PAOs) is that the particles will “cold flow” or stick together after the passage of time, thus making it impossible to place the PAO in the hydrocarbon liquid where drag is to be reduced, in a form of suitable surface area, and thus particle size, that will dissolve or otherwise mix with the hydrocarbon in an efficient manner. Further, the grinding process or mechanical work employed in size reduction may sometimes undesirably and unpredictably degrade the polymer, thereby lowering the drag reduction efficiency of the polymer.

One of the more conventional grinding procedures requires cryogenic conditions in hammer mill grinding to reduce the dry solid polymeric drag reducing agent to a fine particle size. Cryogenic conditions are often defined as operating the grinding process at or below the glass transition temperature of the polymer.

Gel or solution DRAs (those polymers essentially being in a viscous solution with hydrocarbon solvent) have also been tried in the past. However, these drag reducing gels demand specialized injection equipment, as well as pressurized delivery systems. The gels or the solution DRAs are stable and have a defined set of conditions that have to be met by mechanical equipment to pump them, including, but not necessarily limited to viscosity, vapor pressure, undesirable and/or uncontrollable degradation due to shear, etc. The gel or solution DRAs are also limited to about 10% activity of polymer as a maximum concentration in a carrier fluid due to the high solution viscosity of these DRAs. Thus, transportation costs of present DRAs are considerable, since up to about 90% of the volume being transported and handled is inert material.

Canadian patent 675,522 involves a process of comminuting elastomeric material for the production of small particles that includes presenting a large piece of elastomeric material to a comminuting device, feeding powdered resinous polyolefin into the device, comminuting the elastomeric material in the presence of the powdered polyolefin and recovering substantially free-flowing comminuted elastomeric material.

A polymer emulsification process comprising intimately dispersing a liquified water insoluble polymer solution phase in an aqueous liquid medium phase containing at least one nonionic, anionic or cationic oil-in-water functioning emulsifying agent, in the presence of a compound selected from the group consisting of those hydrocarbons and hydrocarbyl alcohols, ethers, alcohol esters, amines, halides and carboxylic acid esters which are inert, non-volatile, water insoluble, liquid and contain a terminal aliphatic hydrocarbyl group of at least about 8 carbon atoms, and mixtures thereof are described in U.S. Pat. No. 4,177,177. The resulting crude emulsion is subjected to the action of comminuting forces sufficient to enable the production of an aqueous emulsion containing polymer solution particles averaging less than about 0.5 microns in size. The polymers of this patent are not identified as or suggested to be drag reducing polymers.

A technique for rapid dissolution or dispersion on essentially the molecular level, of certain polymeric materials in compatible liquid vehicles is described in U.S. Pat. No. 4,340,076. The polymeric materials are comminuted at cryogenic temperatures and are then introduced into a liquid vehicle preferably while still at or near cryogenic temperatures. At low concentrations, the resulting blend or system displays reduced friction to flow while high concentrations may be used to immobilize the liquid vehicle and/or reduce its vapor pressure.

From reviewing the foregoing prior patents it can be appreciated that considerable resources have been spent on both chemical and physical techniques for easily and effectively delivering drag reducing agents to the fluid that will have its friction or fluid turbulence reduced. Yet none of these prior methods has proven entirely satisfactory. Thus, it would be desirable if a drag reducing agent could be developed which rapidly dissolves in the flowing hydrocarbon (or other fluid), which could minimize or eliminate the need for special equipment for preparation and incorporation into the hydrocarbon, and which could be formulated to contain much greater than 10% polymer. If the DRA product contains only 10% polymer, considerable cost is involved in shipping, storing and delivering the other 90% of the material that is essentially inert, i.e. does not function as a drag reducer. It would also be desirable to have a process for producing a slurry of particulate drag reducing agent that did not require cryogenic grinding of the solid polymer prior to slurry formulation.

It is known to use high shear materials processors such as homogenizers in the scientific literature for various materials, but it is not known to use such apparatus and processes on drag reducing materials such as polymers within the context of particle size reduction, drag reduction and molecular weight reduction. However, U.S. Pat. No. 6,894,088 to Motier, et al. relates to a process for producing DRA slurries by homogenizing without cryogenic temperatures or conventional grinding.

### SUMMARY

There is provided, in one non-restrictive form, a method for producing a polymer drag reducing agent (DRA) slurry, involving feeding to a high shear materials processor components that include a pre-ground polymer DRA; and at least one liquid, non-solvent for the polymer DRA; and then shearing the components at high pressure to simultaneously reduce the particle size of the polymer DRA, percent drag efficiency and the molecular weight of the polymer DRA to yield a polymer DRA slurry.

In another non-limiting embodiment of the invention, there is provided a method for producing a slurry of particulate polymer drag reducing agent that involves feeding to a high shear homogenizer a pre-ground polymer coarsely ground to about 500 micron average particle size, such as by using the rotor/stator technology of U.S. Pat. No. 6,894,088 to Motier, et al. while suspended in a non-solvent for the polymer. The polymer may have been previously pre-ground using a solid or a liquid anti-agglomeration agent or a combination thereof. The components are then homogenized through the “high shear materials processor” to produce a slurry of finely divided particulate polymer drag reducing agent in a non-solvent for the polymer. The size of the particles and the molecular weight of the particles are simultaneously reduced. In one non-limiting embodiment of the invention, cryogenic temperatures are not used in the process. In another aspect of the invention, the invention includes the particulate polymer drag reducing slurry made by these processes.

It is very difficult or impossible to measure molecular weights of these polymers in this process by any absolute means. The percent drag efficiency discussed relates indirectly to molecular weight. The percent drag efficiency is a solution property of the polymer DRA also directly related to the size of polymer in solution (viscosity of the polymer). These relationships are sufficiently discussed and known in the literature.

### BRIEF DESCRIPTION OF THE DRAWINGS

FIG. 1 is a graph of the effect of polymer molecular weight on the dissolution of DRA polymers for four polyolefin DRA products;

FIG. 2 is a graph of the effect of homogenization pressure on the average particle size of polymer DRA particles; and

FIG. 3 is a graph of the effect of homogenization pressure on the molecular weight of polymer DRA particles.

### DETAILED DESCRIPTION

A method has been discovered for efficiently and controllably reducing the particle size of a bulk polymer along with its molecular weight using a high shear materials processor, such as a high pressure homogenizer or apparatus such as MICROFLUIDIZER® fluid processors available from MFIC Corporation. As has been previously observed, the reduction in particle size can also lead to controlled, predetermined and predictable reduced molecular weight or size of the polymer, as well as enhanced dissolution rates. Hence, reduced size (both molecular weight and particle size) generated by the process yields a quick dissolving polymer, heretofore unrealized in the DRA industry.

Polymer particle size reduction occurs due to the high shear generated by the high shear materials processor while the polymer passes through the orifices and the cavitation chambers in a high pressure homogenizer and through the narrow chambers in a high shear materials processor such as a MICROFLUIDIZER. Reduction of particle size to the 50-200 micron range is expected to lead to a reduction in drag. Predictability and control is provided by controlling the pressures used, as well as other parameters that will be discussed. Hence, with an initial sample of known drag efficiency, a designed, predictable drag reducing material may be produced by setting the pressure on the high shear materials processor.

Ambient grinding using a rotor-stator is efficient down to about 300 microns. Reducing polymer size below 300 microns is difficult using conventional rotor-stators. Homogenizers and other high shear materials processors are efficient in the lower particle size range. Bulk polymer particle size may be reduced below about 300 microns, and in another non-limiting embodiment below about 200 microns using these homogenizer devices, and in a further non-restrictive embodiment below about 100 microns. “Bulk polymer” refers to a polymer made by bulk polymerization.

Homogenizers or “thigh shear material processors” develop a high pressure on the material whereby the mixture is subsequently transported through a very fine orifice on the order of 0.13 mm-0.25 mm. The flow through the chambers can be reverse flow or parallel flow depending on the material being processed. The number of chambers can be increased to achieve better performance. The orifice size may also be changed for optimizing the particle size generated. Polymer particle size reduction occurs due to the high shear generated by the homogenizer while it passes through the orifice and the chambers. A MICROFLUIDIZER-type apparatus also develops a high pressure on the material to be processed and passes it through chambers where high shear imparted to the polymer particles reduces its size. Reduction of particle size below the 200 micron range is expected to lead to reduction in drag. Thus, starting with a polymer sample of known percent drag efficiency, a required DRA material may be produced by this method without any change in the chemistry of the polymer (or the process of producing the polymer) by simply setting or changing the pressure on the high shear materials processor. Or stated another way, the molecular weight of the DRA polymer is reduced by a physical or mechanistic process rather than a chemical one. Polymer slurry products with different molecular weights, viscosities, solids concentrations and initial particle sizes can be processed and produced by the high shear materials processor. Furthermore, better particle size control may be achieved by increasing the number of passes.

In one non-limiting embodiment, the invention concerns the preparation of drag reducing slurry products of high molecular weight polymer particles using multi-stage high shear materials processors. In one non-restrictive context of this invention, these machines are defined as “homogenizers”. In another non-limiting embodiment, homogenizers include at least one rotor-stator combination, and the material being homogenized is cycled through the homogenizer in multiple passes until the desired average particle size is reached. Suitable homogenizers include, but are not necessarily limited to Ross QUAD-X Series mixers and MEGASHEAR homogenizers available from Ross Mixers, Inc.; and the like. In one important non-limiting embodiment of the invention, the formation of the slurry is conducted in the absence of conventional grinding, particularly in the absence of cryogenic grinding.

Homogenizing is a physical, mechanical size reduction process distinct from grinding. As discussed herein, homogenizing reduces polymer particle size with controlled and predictable degradation or desired breaking of the polymer chains, and creates a stable colloidal system. In one non-limiting embodiment the size reduction is accomplished by passing the polymer through a homogenizer such as a colloid mill, a machine having small channels, under a pressure of e.g. 2000-2500 psi (about 14,000-17,000 kPa) at a speed of approximately 700 ft/sec (about 210 m/sec). The forces involved include shear, impingement, distention, and cavitation. Conventional grinding, by contrast, can sometimes damage and undesirably break and degrade the polymer chains during size reduction. It is also a physical or mechanical process that crushes bits or particles between two hard surfaces.

Alternatively, the pressures in a high shear materials processor may range from about 1000 psig to about 50,000 psig (about 6.9 MPa to about 345 MPa) in another non-limiting embodiment, from a lower limit of about 15,000 independently to an upper limit of about 40,000 psig (about 103 MPa to about 276 MPa) in a different, non-restrictive version.

The initial polymer DRA to be sheared or ground, in some cases in the form of pre-ground polymer DRA, the polymer has an average % DR at 0.28 ppm polymer concentration of between about 66% DR and about 50% DR, and the average % DR of the resulting sheared polymer DRA after high shear materials processing is equal to or less than about 55% DR. This polymer chain breaking, scission or degradation is directly dependent upon the pressure used in the high shear materials processor. In general, the higher the pressure, the greater the shear forces and the more polymer chain breaking occurs. In another non-limiting embodiment, the initial polymer has an average % DR at 0.28 ppm polymer concentration of between about 60% DR and about 55% DR, and the average % DR of the resulting sheared polymer DRA after high shear materials processing is equal to or less than about 55% DR. The high shear process may be understood to be somewhat analogous to cutting up a rubber band. A rubber band or elastomer band has an overall ultimate viscoelastic property as a single unit. When the band is cut up into pieces the individual pieces still retain viscoelastic properties, however, the individual pieces will not retain the overall strength characteristics of the band as a whole.

Prior to the high shear processing of this invention, the polymer has already been pre-ground, that is, broken up or otherwise fragmented into granules in the range of about 300 to 1000 microns, in an alternate non-limiting embodiment from a lower limit of about 500 independently to an upper limit of about 700 microns, where the average particle size of the sheared, homogenized polymer DRA is equal to or less than about 300 microns, alternatively less than about 200 microns, and in a different embodiment less than about 100 microns. This size reduction is directly dependent upon the pressure used in the high shear materials processor. In general, the higher the pressure, the greater the shear forces and the smaller the particles. As noted, however, the number of passes through the high shear materials processor also has a direct effect on the ultimate particle size, where the higher number of passes or increased residence time produces smaller particles.

It will be appreciated that within the context of the methods and compositions herein, in one non-limiting embodiment as noted the polymer DRA is pre-ground in contrast to being granulated. In U.S. Pat. No. 6,894,088, the polymer DRA is granulated prior to homogenization. This is in contrast to being pre-ground as defined herein.

In one non-limiting embodiment of this invention, the high shear processes for producing particulate polymer drag reducing agent are conducted at non-cryogenic temperatures. For the purposes of this invention, cryogenic temperature is defined as the glass transition temperature (T_{g}) of the particular polymer having its size reduced or being homogenized, or below that temperature. It will be appreciated that T_{g} will vary with the specific polymer being ground. Typically, T_{g} ranges between about −10° C. and about −100° C. (about 14° F. and about −148° F.), in one non-limiting embodiment, and alternatively between about −10° C. and about −80° C. (about 14° F. and about −112° F.). In another non-limiting embodiment of the invention, the high shear process for producing the slurry of particulate polymer drag reducing agent is conducted at ambient temperature. For the purposes of this invention, ambient temperature conditions are defined as between about 20-25° C. (about 68-77° F.). In another non-limiting embodiment of the invention, ambient temperature is defined as the temperature at which high shearing occurs without any added cooling. Because heat is generated in the shearing process, “ambient temperature” may thus in some contexts mean a temperature greater than about 20-25° C. (about 68-77° F.), in one non-limiting example from about 25 to about 80° C. In still another non-limiting embodiment of the invention, the homogenizing to produce particulate polymer drag reducing agent is conducted at a chilled temperature that is less than ambient temperature, but that is greater than the glass temperature for the specific polymer being homogenized. A preferred chilled temperature may range from about −7 to about 2° C. (about 20 to about 35° F.), in one non-limiting embodiment of the invention.

Generally, the polymer that is processed in the method of this invention may be any conventional or well known polymeric drag reducing agent (DRA) including, but not necessarily limited to, poly(alpha-olefin), polychloroprene, vinyl acetate polymers and copolymers, poly(alkylene oxide), and mixtures thereof and the like. For the method of this invention to be successful, the polymeric DRA would have to be of sufficient structure (molecular weight) to exist as a neat solid which would lend itself to the homogenizing and other high shear processes, i.e. that of being sheared by mechanical forces to smaller particles.

Poly(alpha-olefin) is a preferred polymer in one non-limiting embodiment of the invention. Poly(alpha-olefins) (PAOs) are useful to reduce drag in flowing hydrocarbon pipelines and conduits. As mentioned, prior to the process of this invention, the polymer has already been pre-ground, that is, broken up or otherwise fragmented into granules. It is permissible for the pre-ground polymer to have an anti-agglomeration agent thereon. Such anti-agglomeration agents include, but are not necessarily limited to talc, alumina, ethylene bis-stearamide, polyethylene waxes, lower molecular PAOs and the like and mixtures thereof.

Within the context of the methods and slurries herein, the term “pre-gdnd” refers to any size reduction process that produces a product that is relatively larger than that produced by high shear processing. Further within the context of the methods and slurries herein, “homogenizing” and “high shear processing” refer to a size reduction process that yields a product relatively smaller (or smaller particle size) than that produced by “pre-grinding”. An advantage of high shear materials processing is that degradation of the polymer occurs controllably and predictably during the process, as contrasted with some other methods of size reduction. In turn “grinding” is understood herein to produce a particle or product that is relatively smaller than that produced by “granulating”.

The optional solid organic anti-agglomeration agent (also known as processing aids) may be any finely divided particulate or powder that inhibits, discourages or prevents particle agglomeration and/or gel ball formation during homogenizing. The solid organic processing aid may also function to provide the shearing action necessary in the size reduction step to achieve polymer particles of the desired size. The solid organic processing aid itself has a particle size, which in one non-limiting embodiment of the invention ranges from about 1 to about 50 microns, preferably from about 10 to about 50 microns. Suitable solid organic processing aids include, but are not necessarily limited to, ethene/butene copolymer (such as Microthene, available from Equistar, Houston), polyethylene waxes (such as those produced by Baker Petrolite), solid, high molecular weight alcohols (such as Unilin alcohols available from Baker Petrolite), and any non-metallic, solid compounds composed of C and H, and optionally N and/or S which can be prepared in particle sizes of 1-50 microns or alternatively 10-50 microns suitable for this process, and mixtures thereof.

The non-solvent provides lubricity to the system during high shear molecular weight and particle size reduction. Specific examples of non-solvents include, but are not necessarily limited to, a blend of a glycol with water and/or an alcohol. Suitable glycols include, but are not necessarily limited to, ethylene glycol, propylene glycol, diethylene glycol, dipropylene glycol, methyl ethers of such glycols, and the like, and mixtures thereof. Suitable alcoholic liquids include, but are not necessarily limited to, methanol, ethanol, isopropanol (isopropyl alcohol, IPA), butanol, hexanol and the like and mixtures thereof. In another non-limiting embodiment of the invention, the non-solvent includes, but is not necessarily limited to, alcohols, glycols, glycol ethers, and esters; where the non-solvent has from 2-6 carbon atoms, and water and combinations thereof. In one non-limiting embodiment of the invention, the non-solvent is a blend of an ether and an alcohol, in weight proportions ranging from about 75/25 to about 25175, and in another non-limiting embodiment ranging from a lower limit of about 60/40 independently to an upper limit of about 40/60.

In one non-limiting embodiment of the invention, the proportion of pre-ground polymer DRA to the non-solvent ranges from about 5 to about 40 wt %, based on the total combination, prior to high shear processing. In another non-limiting embodiment, the proportion of pre-ground polymer DRA to the non-solvent ranges from a lower limit of about 20 independently to an upper limit of about 50 wt %.

In one non-restrictive version of the invention, it is expected that the processes described herein will produce particulate polymer drag reducing agent product where the average particle size is less than about 600 microns, preferably where at least 90 wt % of the particles have a size of less than about 600 microns or less, 100 wt. percent of the particles have a size of 500 microns or less, and most preferably 61.2 wt. % of the particles have a size of 297 microns or less in non-limiting embodiments, prior to the feed to the homogenizer or high shear materials processor. One achievable distribution is shown in Table I where the average particle size is less than 300 microns, but other distributions are certainly possible, and the invention is not necessarily limited to this particular embodiment:

TABLE I

| Micron Retained | Screen Mesh Size | Percent |
|---|---|---|
| 500 | 35 | 38.8 |
| 297 | 50 | 55.7 |
| 210 | 70 | 4.1 |
| 178 | 80 | 0.4 |
| 150 | 100 | 0.4 |
| pan | pan | 0.6 |

Other components of the slurry product may include, but are not necessarily limited to, emulsifiers, surfactants and other surface-tension reducers. Suitable emulsifiers for this invention include, but are not necessarily limited to, alcohol ethoxylates, alkyl aromatic sulfonates and the like. Other optional additives to the slurry include polymers or cellulosic derivatives soluble in the carrier fluid or activated clays. However, in one non-limiting embodiment of the invention, the slurry has an absence of an emulsifier or emulsifying agent. In the embodiment where an emulsifier is not used, the high shear materials processor can nevertheless produce a stable emulsion or slurry in the absence of an added emulsifier. In another non-limiting embodiment, the slurry is not an emulsion. In still another non-limiting embodiment of the invention, the slurry has an absence of water. In this last embodiment, the liquid, non-solvent does not include water.

The invention will now be further described with respect to specific examples that are provided only to further illustrate the invention and not limit it in any way.

### EXAMPLES

The molecular weight of drag reducing agent (DRA) polymers can be controlled chemically or mechanistically through a combination of reaction temperature, catalyst concentration, co-catalyst concentration, and relative monomer ratios. The resulting ultra-high molecular weight polymers cannot be accurately analyzed via traditional solution molecular weight measurement techniques such as Gel Permeation Chromatography or Light Scattering due to the degradative shear forces involved in both techniques. An indirect measurement of molecular weight is performed by relating the percent drag efficiency (i.e. a correlative function of viscosity or size of molecule in solution). Thus, the percent drag efficiency determination is initiated by first dissolving the ultra-high molecular weight polymer DRA in a solvent, e.g. hexane. By pumping a solvent such as hexane at a constant flow rate through a tube of known diameter and measuring the pressure drop across a fixed section of the tube a baseline pressure drop for the solvent in use is obtained. Subsequently, the polymer DRA dissolved in hexane is pumped through the same calibrated tube at an equivalent flow rate as the baseline hexane and the pressure drop again measured. The ratio of the pressure drop with and without dissolved DRA polymer multiplied by 100 produces a value of inherent Percent (%) Drag Reduction (% DR) which is considered an indirect measurement for the molecular weight of the polymer. The higher the % DR obtained by this measurement, the higher the molecular weight of the polymer.

Ultra-high molecular weight DRA polymers of varying molecular weight were made via bulk polymerization techniques as outlined in U.S. Pat. No. 7,015,290 and the resulting polymers were reduced in size via grinding techniques patented in U.S. Pat. No. 6,894,088, both incorporated by reference herein. Table II below shows the average particle size of the various products and their corresponding inherent % DR measured at a polymer concentration of 0.28 parts per million (ppm) in hexane solvent.

TABLE II
DRA Polymers of Varying Molecular Weight Prepared Via Chemical
Manipulation.

| | | | Inherent % DR at |
|---|---|---|---|
| Ex. | Product | Avg. Particle Size, microns | 0.28 ppm Polymer |
| 1 | Product A | 240 | 20 |
| 2 | Product B | 240 | 35 |
| 3 | Product C | 240 | 43 |
| 4 | Product D | 240 | 55 |

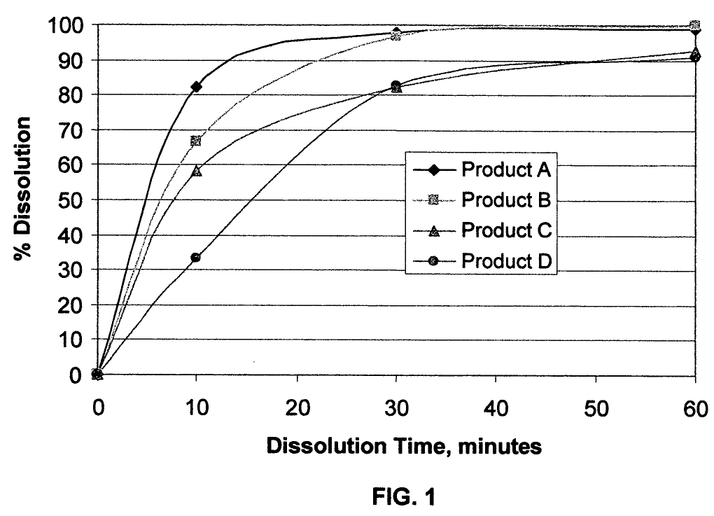

In an actual pipeline transporting hydrocarbon fluids such as crude oil, diesel or gasoline and the like, the polymer DRA has to dissolve and mix with the hydrocarbon fluids in question in order to effectively reduce drag or significantly reduce turbulent flow (via the effect of viscoelastic properties of the ultra-high molecular weight polymer within the fluid). Ultra-high molecular weight polymers that dissolve quickly are especially effective in short pipelines where the opportunity to dissolve and be effective as a DRA is limited within the constraints of dissolution time. Lab dissolution techniques were utilized to determine the rate of dissolution of the various ultra-high molecular weight polymers in a given solvent. In a typical lab dissolution test, samples are analyzed at 10 minutes, 30 minutes, and 60 minutes to determine a percent drag which directly relates to the quantity of polymer dissolved in solution (a rate of dissolution, polymer dissolved/performance per time). The samples in the Table II were analyzed for dissolution and the results shown in the FIG. 1. It is clearly seen that the product with the lowest inherent % DR (or molecular weight) gave the fastest dissolution and the product with the highest inherent % DR (or molecular weight) displayed the slowest dissolution.

High pressure homogenizers have been typically used to de-agglomerate (re-disperse) and reduce particle size of a wide variety of materials such as proteins, clays and polymers. The use of high pressure homogenizers to control molecular weight and particle size of DRA polymers would be of great benefit to generate quickly dissolving polymer DRA formulations to be used in hydrocarbon transportation pipelines.

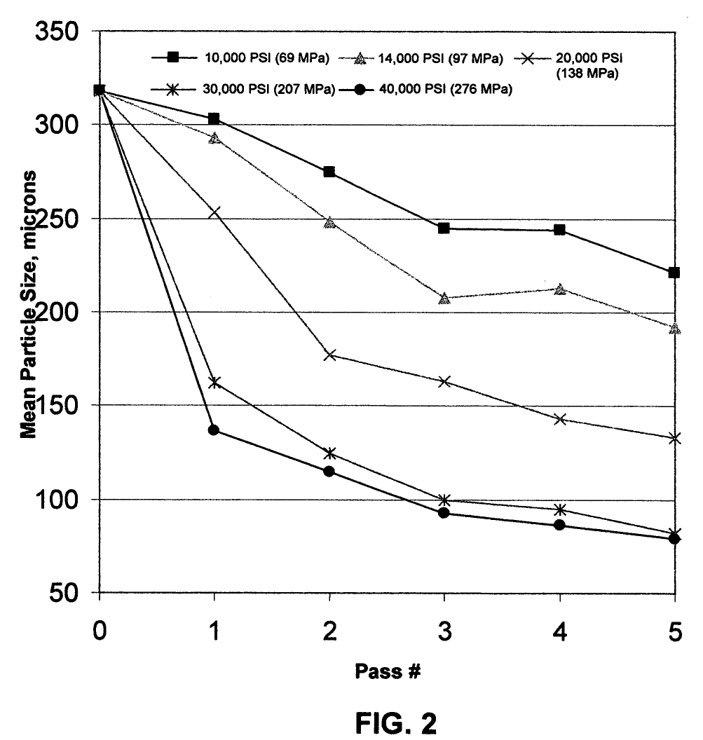

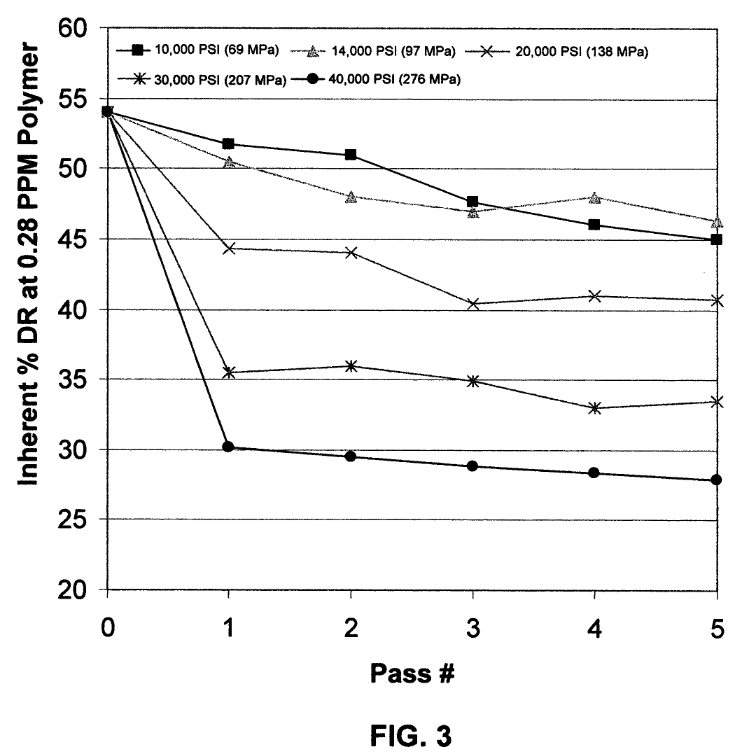

The effect of pressure on average particle size and molecular weight (as measured by inherent % DR) is shown in FIGS. 2 and 3. At each pressure, the polymer DRA formulation was passed through the homogenizer up to 5 times and samples were collected for analysis on each pass. A strong dependence of average particle size was seen with varying pressure. It is expected, for the same polymer DRA molecular weight (inherent % DR), that lower average particle size polymer DRA formulations should dissolve faster than higher average particle size polymer DRA formulations.

The effect of pressure and number of passes on the polymer molecular weight (measured at inherent % DR at 0.28 ppm polymer in hexane) is shown in FIG. 3. There is a strong correlation between the pressure applied for homogenization and the resulting lower molecular weight of the polymer. Using pressure as the controlling variable, it was possible to generate DRA polymers via homogenization comparable to those DRA polymers as prepared by manipulating mechanistic variables (seen in Table II). For example by using 20,000 psi (138 MPa) to homogenize a polymer DRA formulation, the molecular weight of the polymer DRA can be made to closely match Product C in Table II. Also, by using 30,000 psi (207 MPa) to homogenize a polymer DRA formulation, the molecular weight of the polymer DRA can be made to mimic Product B in Table II. Thus, curves such as those seen in FIGS. 2 and 3 may be used to predict the particle size and/or percent drag efficiency of the polymer DRA in the slurries formed by the methods described herein.

It has thus been demonstrated that the process described herein may produce a slurry of a particulate polymer drag reducing agent of suitable small particle size and adequate surface area that will readily dissolve and dissipate (disperse or mix vs. dissipate) in flowing hydrocarbon streams, as well as reducing its molecular weight. Further, the methods herein may provide a particulate polymer DRA in slurry form that can be readily manufactured and which does not require cryogenic temperatures to be produced. Additionally, the methods and processes described herein may simultaneously control the molecular weight, drag reduction (percent drag efficiency vs. drag reduction) and particle size of the polymer DRA. Also, the procedures and methods herein may provide a particulate polymer DRA in slurry form that does not cold flow upon standing once it is made.

Many modifications may be made in the composition and process of this invention without departing from the spirit and scope thereof that are defined only in the appended claims. For example, the exact nature of, size of and proportions of pre-ground polymer DRA and the nature of and proportion of the non-solvent may be different from those used here. Particular processing techniques may be developed to enable the components to be homogeneously blended and work together well, yet still be within the scope of the invention. Additionally, feed rates of the various components are expected to be optimized for each type of high shear materials processor equipment and for each combination of components employed. It is also expected that the ambient grinding techniques of U.S. Pat. Nos. 6,894,088 B1; 6,649,670 B1; 6,946,500 and U.S. patent application Ser. No. 2004/013288 A1; all of which are incorporated by reference herein in their entirety, may be used to form particulate polymer DRAs that could be incorporated into slurries such as those of this invention.

What is claimed is:

1. A method for producing a polymer drag reducing agent (DRA) slurry, comprising:
feeding to a high shear materials processor components comprising:
a pre-ground polymer DRA; and
at least one liquid, non-solvent for the polymer DRA; and
shearing the components at a high pressure to simultaneously reduce the particle size of the polymer DRA, percent drag efficiency and the molecular weight of the polymer DRA to yield a polymer DRA slurry.

2. The method of claim 1 where the polymer DRA slurry has a percent drag efficiency which is reduced by the shearing as compared to an identical polymer DRA slurry that is not sheared.

3. The method of claim 1 where the pressure is controlled to yield a predetermined particle size and molecular weight.

4. The method of claim 1 where the pre-ground polymer DRA has an average particle size between about 300 microns and about 1000 microns, and the average particle size of the sheared polymer DRA is less than about 300 microns.

5. The method of claim 1 where the pre-ground polymer DRA has an average % DR at 0.28 ppm polymer concentration of between about 66% DR and about 50% DR, and the average % DR of the sheared polymer DRA is equal to or less than about 55% DR.

6. The method of claim 1 where the high pressure ranges from about 1000 psi (6.9 MPa) to about 50,000 psi (345 MPa).

7. The method of claim 1 where the pre-ground polymer DRA is a poly(alpha-olefin).

8. The method of claim 1 where the shearing is conducted in the absence of cryogenic temperatures.

9. The method of claim 1 where the feeding and shearing are conducted at ambient temperatures.

10. The method of claim 1 where the liquid, non-solvent is selected from the group of compounds consisting of alcohols, glycols, glycol ethers, ketones, and esters, where the compound has from 2-6 carbon atoms, and water and combinations thereof.

11. A method for producing a polymer drag reducing agent (DRA) slurry, comprising:
feeding to a high shear materials processor components comprising:
a pre-ground poly(alpha-olefin); and
at least one liquid, non-solvent for the polymer DRA, where the liquid, non-solvent is selected from the group of compounds consisting of alcohols, glycols, glycol ethers, and esters, where the compound has from 2-6 carbon atoms, and water, and combinations thereof; and
shearing the components at a high pressure in the range of from about 1000 (6.9 MPa) to about 50,000 psi (345 MPa) to simultaneously reduce the particle size of the polymer DRA and the molecular weight of the polymer DRA to yield a polymer DRA slurry.

12. The method of claim 11 where the pre-ground polymer DRA has an average particle size between about 300 microns and about 1000 microns and an average % DR at 0.28 ppm polymer concentration of between about 66% DR and about 50% DR, and the average particle size of the sheared polymer DRA is less than about 300 microns with an average % DR of the sheared polymer DRA is equal to or less than about 55% DR.

13. The method of claim 11 where the shearing is conducted in the absence of cryogenic temperatures.

14. The method of claim 11 where the feeding and shearing are conducted at ambient temperatures.

15. A polymer drag reducing agent (DRA) slurry made by a method comprising:
feeding to a high shear materials processor components comprising:
a pre-ground polymer DRA; and
at least one liquid, non-solvent for the polymer DRA; and
shearing the components at a high pressure to simultaneously reduce the particle size of the polymer DRA and the molecular weight of the polymer DRA to yield a polymer DRA slurry, where the average particle size of the sheared polymer DRA is less than about 300 microns and where the average % DR of the sheared polymer DRA is equal to or less than about 55% DR.

16. The polymer DRA slurry of claim 15 where the high pressure is controlled to yield a predetermined particle size and molecular weight.

17. The polymer DRA slurry of claim 15 where the pre-ground polymer DRA has an average particle size between about 300 microns and about 1000 microns.

18. The polymer DRA slurry of claim 15 where the pre-ground polymer DRA has an average % DR at 0.28 ppm polymer concentration of between about 66% DR and about 50% DR.

19. The polymer DRA slurry of claim 15 where the high pressure ranges from about 1000 to about 50,000 psi.

20. The polymer DRA slurry of claim 15 where the pre-ground polymer DRA is a poly(alpha-olefin).

21. The polymer DRA slurry of claim 15 where the shearing is conducted in the absence of cryogenic temperatures.

22. The polymer DRA slurry of claim 15 where the feeding and shearing are conducted at ambient temperatures.

23. The polymer DRA slurry of claim 15 where the liquid, non-solvent is selected from the group of compounds consisting of alcohols, glycols, glycol ethers, and esters, where the compound has from 2-6 carbon atoms, and water, and combinations thereof.
